(19) United States
(12) Patent Application Publication
(10) Pub. No.: US 2024/0263566 A1
(43) Pub. Date: Aug. 8, 2024

(54) PRE-SWIRL NOZZLE SYSTEM IN A GAS TURBINE AND PRE-SWIRL NOZZLE SYSTEM

(71) Applicant: Rolls-Royce Deutschland Ltd & Co KG, Blankenfelde-Mahlow (DE)

(72) Inventors: Oliver FREUND, Berlin (DE); Stefan FECHNER, Berlin (DE)

(21) Appl. No.: 18/433,732

(22) Filed: Feb. 6, 2024

(30) Foreign Application Priority Data
Feb. 8, 2023 (DE) 10 2023 103 082.5

(51) Int. Cl. F01D 25/12; F01D 5/14

(52) U.S. Cl. CPC F01D 25/12; F01D 5/141

(57) ABSTRACT

The invention relates to a pre-swirl nozzle system in a gas turbine, in particular in an aircraft engine, having at least one pre-swirl nozzle, through which cooling air can flow, characterized in that the at least one pre-swirl nozzle has a region with a constant first cross section and a downstream region with a second cross section, which expands in the flow direction, in particular expands in a strictly monotonic manner.

This application claims priority to German Application No. 10 2023 103 082.5 filed Feb. 8, 2023, which application is incorporated by reference herein.

### DESCRIPTION

The present disclosure relates to a pre-swirl nozzle system having the features of claim 1 and to a pre-swirl nozzle method having the features of claim 15.

In modern gas turbines, especially aircraft engines, the aim is, in particular, to increase the turbine inlet temperature in order to improve the efficiency of the turbine. The turbine inlet temperature may be above 1500° C., and therefore efficient cooling, particularly of the turbine inlet stage, is required. For this purpose, the secondary air system of the gas turbine must be of efficient design in order to supply cooling air at an appropriate pressure, temperature and mass flow.

Pre-swirl nozzle systems for reducing the energy loss of the cooling air during the transition from the stationary component of the secondary air system to the rotating component of the turbine inlet stage are known in principle (e.g. from CN 105464724 B, CN 105888850 A and US 2016/0108751 A1).

By aligning the cooling air at an angle relative to the turbine inlet stage, it is possible to minimize the pressure loss in order to keep both the pressure and the mass flow in the rotating cooling path as high as possible. In addition, the relatively high peripheral velocity of the cooling air lowers the relative overall temperature at the rotating parts.

The object is to provide pre-swirl nozzle systems for efficient cooling.

In this case, at least one pre-swirl nozzle has a region with a constant first cross section and a downstream region with a second cross section, which expands in the flow direction, in particular expands in a strictly monotonic manner. Here, in contradistinction to known pre-swirl nozzles with cross sections for the cooling air flow which are constant throughout, a region with a constant cross section is followed by a diffuser region, resulting in regions of different velocity within the pre-swirl nozzle. As a result, there is the possibility of setting the mass flow and the exit velocity independently of one another, thus enabling the two variables to be set independently of one another with a view to optimum cooling efficiency of the turbine components.

In this case, the cross sections can each have a circular shape, a polygonal shape or an elliptical shape. For efficient flow guidance, it is expedient if centre lines of the first cross section and of the second cross section are in alignment in the flow direction. However, it is also possible in principle for the centre lines of the cross sections to lie on a curved path.

In a first embodiment, the widening of the second cross section to form a diffuser can take place partially or entirely in a linear manner in the flow direction. This means that, at least in some section or sections, the cross-sectional area expands in a linear manner in the direction of the flow of the cooling air. In this case, the region with the expanding second cross section can form a conical diffuser wall region of the pre-swirl nozzle if the cross-sectional shape in this region is circular. The conical diffuser wall region of the pre-swirl nozzle typically has an angle α of between 1 and 6°, in particular 2.5°, to the centre line.

In a second embodiment, the widening of the second cross section to form a diffuser takes place partially or entirely in a non-linear manner in the flow direction. Thus, in this embodiment, there is, in particular, no conical wall region; instead there is, for example, an increasingly expanding wall region. Thus, the non-linear widening of the second cross section can form a diffusor wall region which expands exponentially in the flow direction.

However, it is also possible for the widening of the second cross section to take place partially in a linear manner and partially in a non-linear manner, i.e. hybrid forms of the increases in cross section are possible.

In each case, the transition between the region with the constant first cross section and the downstream region with the second cross section can have a sharp edge or a rounding.

When used in an aircraft engine, the diameter of the first cross section of the pre-swirl nozzle can be between 1 and 12 mm, in particular 5 mm.

The maximum diameter of the second cross section of the pre-swirl nozzle would then be, in particular, greater than the first cross section and—depending on the size of the first cross section—would be between 2 and 13 mm, in particular 6 mm. If, for example, a first circular cross section with a constant diameter of 6 mm is assumed, this would be followed by the second region (diffuser region) with a diameter of 6 mm, which can then expand to a diameter of 8 mm. The inlet cross section of the second region thus corresponds to the cross section of the first region.

In principle, it is possible here for the ratio of the length of the region of the first, constant, cross section to the length of the region with the second, widening, cross section to be between 0.1 and 0.5, in particular 0.3.

For efficient cooling, e.g. of a turbine stage, the direction of the outlet opening of the pre-swirl nozzle is aligned with the direction of an inlet opening of a rotating component of the turbine stage.

The object is also achieved by pre-swirl nozzle methods having the features of claim 15, wherein the exit velocity of the cooling air from the pre-swirl nozzle can be set by means of the geometry of the cross sections, independently of the mass flow of the cooling air.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

Embodiments will now be described by way of example with reference to the figures, in which:

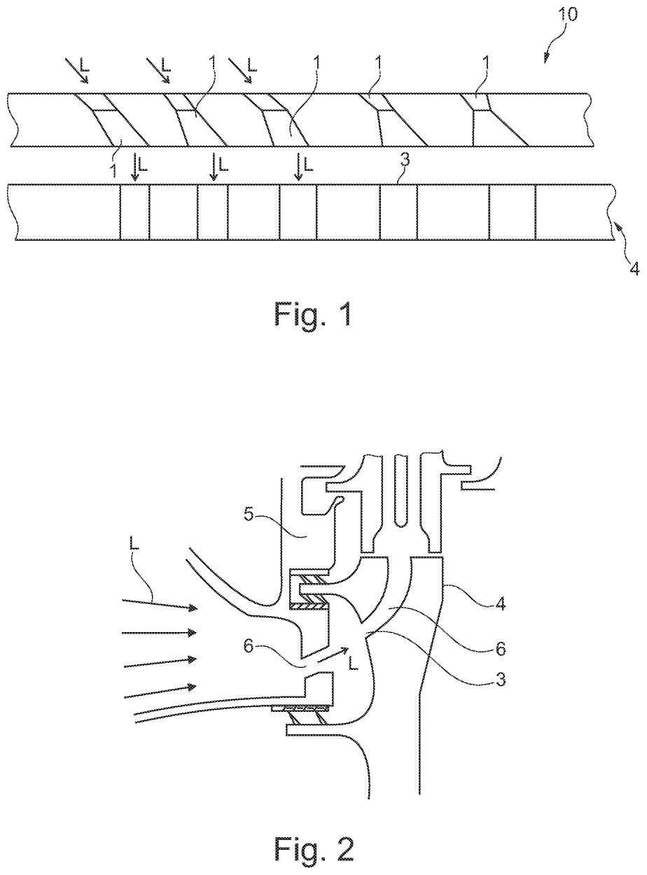

FIG. 1 shows a schematic illustration of a pre-swirl nozzle system for generating swirl in cooling air;

FIG. 2 shows a schematic illustration of an embodiment of a pre-swirl nozzle system and an inlet stage of a high-pressure turbine stage;

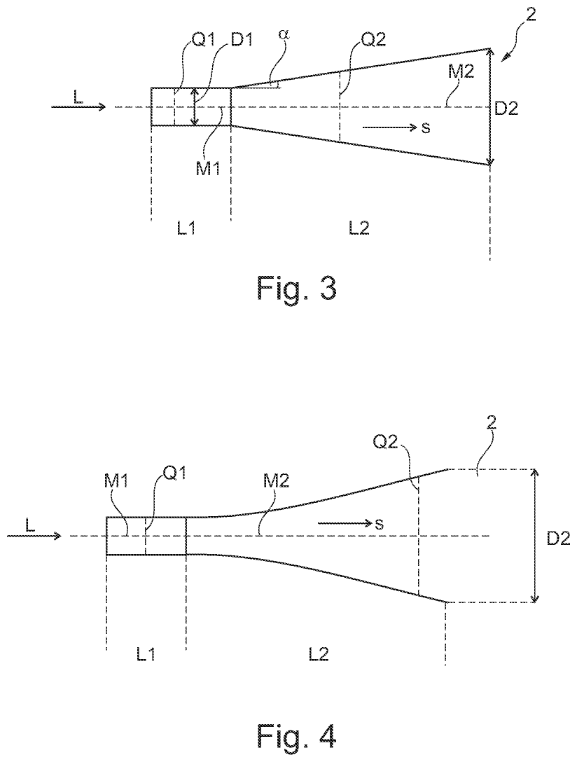

FIG. 3 shows a schematic sectional view of a pre-swirl nozzle having a diffuser with a linear wall contour to the outlet;

FIG. 4 shows a schematic sectional view of a pre-swirl nozzle having a diffuser with a non-linear wall contour;

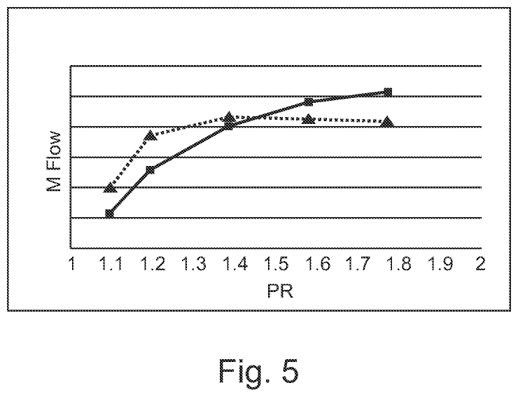

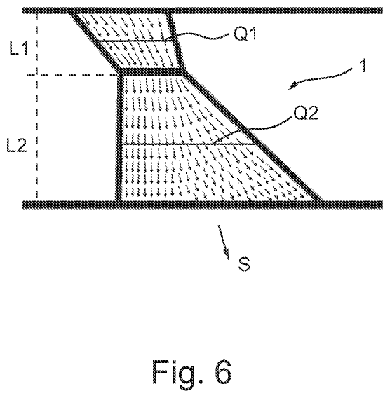

FIG. 5 shows an illustration of the mass flow through one embodiment of a pre-swirl nozzle as a function of a pressure ratio.

FIG. 1 shows the sectional view of a pre-swirl nozzle system 10, which, by way of example, is here arranged in an aircraft engine.

Arranged in a stationary part 5 of the pre-swirl nozzle system 10 is a multiplicity of pre-swirl nozzles 1, the main flow directions of which are inclined relative to the axis of rotation of a rotating part 4 of the aircraft engine, in this case a turbine stage, wherein cooling air L can flow through the pre-swirl nozzles 1. In this case, the cooling air L comes from the secondary air supply system of the aircraft engine, this being illustrated in greater detail in FIG. 2.

The pre-swirl nozzles 1 serve to impress a tangential velocity component on the cooling air L before it enters inlet openings 3 of the rotating component 4. Such a velocity field of the cooling air L leads to more efficient cooling.

FIG. 2 illustrates, by way of example, the use of embodiments of the pre-swirl nozzles 1 in a high-pressure turbine. The high-pressure turbine comprises a first turbine stage, which comprises a stator (the inlet guide wheel, also referred to as NGV (“Nozzle Guide Vane”)) and a rotor.

FIG. 2 shows stationary parts 5 and a rotating part 4, namely the turbine disc 4 and a blade root of the rotor. The guide vanes of the stator and the rotor blades of the rotor, which extend in the main flow path of the high-pressure turbine, are not illustrated in FIG. 2. The components illustrated in FIG. 2 are situated radially at the inside in relation to the main flow path.

Starting from the compressor, the cooling air L is supplied via the secondary air system of the gas turbine engine and emerges through the pre-swirl nozzles 1. The geometry of the pre-swirl nozzles 1 is explained in greater detail in combination with FIGS. 3 and 4. However, it is already apparent in FIGS. 1 and 2 that the cross section of the pre-swirl nozzles 1 changes in the flow direction S.

In the pre-swirl nozzles 1, the cooling air L is diverted and has swirl imparted to it in the direction of rotation of the turbine disc 4. Ideally, the cooling air L has swirl imparted to it such that the direction and magnitude of its tangential velocity correspond to the path velocity of the turbine disc 4 (in the radial region under consideration), and therefore particularly effective cooling can be accomplished.

To ensure that swirl is imparted to the cooling air L, the pre-swirl nozzles 1 are formed obliquely, that is to say with a directional component in a circumferential direction. The cooling air L emerging from the pre-swirl nozzles 1 enters a cooling air duct 6, which is formed in the rotating turbine disc 3. From the cooling air duct 6, the cooling air L enters cooling air ducts which are formed in the blade root of the rotor blades of the rotor and cool these.

In each case, the direction of the outlet opening 2 of the pre-swirl nozzle 1 is aligned with the direction of the inlet opening 3 of the rotating component of the turbine stage 4.

In the case of the known pre-swirl nozzles 1, the flow cross section is constant over the length through which flow occurs; the cross section is circular. On the basis of the continuity equation, an applied mass flow thus also always determines the exit velocity.

In the embodiments illustrated here, the pre-swirl nozzle 1 has a region with a constant first cross section Q1 and a downstream region with a second cross section Q2, which expands in the flow direction S, in particular expands in a strictly monotonic manner. In this case, the embodiments are, in particular, designed in such a way that the respective centre lines M1, M2 of the regions of the pre-swirl nozzle 1 are in alignment with the cross sections Q1, Q2 in the flow direction S.

This is implemented in the exemplary embodiments which are illustrated, each by way of example, in FIGS. 3 and 4.

In this case, a first region with the axial length L1 in each case has a constant cross section Q1 along the flow direction S. Here, the cross section Q1 is circular and has a diameter D1. In alternative embodiments, the cross-sectional shape Q1 can differ from the circular shape, and therefore elliptical or polygonal cross sections Q1 are also possible. These cross sections Q1 can then be characterized by a maximum diameter D1, e.g. the major axis of an ellipse. In the embodiment illustrated, the first region L1 with a constant cross section Q1 is about 3 mm long. The diameter D1 is 5.25 mm.

By virtue of its geometry, this first region with a constant cross section Q1 determines the mass flow of the cooling air L.

Thus, a diffuser region with the axial length L2 is arranged downstream of the first region with the axial length L1. Since the cross section Q2 in this diffuser region expands in the flow direction, the exit velocity can be defined independently of the applied mass flow of the cooling air. In this case, the diffuser leads to a reduction in the exit velocity. In this case, the shape of the cross section Q2 can likewise be circular, polygonal or elliptical, for example.

In this case, the expansion of the cross section Q2 can take place in a strictly monotonic manner, as illustrated in FIGS. 3 and 4. However, it is also possible in principle for the first region L1 to be followed by a partial region which has a constant cross section.

The embodiments in FIGS. 3 and 4 differ in the manner in which the cross section Q2 expands.

In the first embodiment according to FIG. 3, the expansion of the cross section Q2 takes place in a linear manner. Here, the cross-sectional shape is circular over the axial length L2, resulting in a conical wall region which extends over the axial length L2. In principle, it is also possible for the cross section of some other cross-sectional shape to expand in a linear manner.

In the embodiment illustrated in FIG. 3, the angle of inclination a to the centre line M2 is 2.5°. If, for example, the diameter at the inlet of the second region L2 is 5.25 mm, the maximum diameter D2 at the exit of the pre-swirl nozzle 1, which is about 9.5 mm long, is about 6 mm.

In the embodiment according to FIG. 4, in contrast, the expansion of the cross section Q2 takes place in a non-linear manner, in this case, for example, exponentially. If, in the first instance, the same geometrical ratios of the diameters D1, D2 and the lengths L1, L2 as in the abovementioned example are assumed, the wall contour in the second region would correspond approximately to the equation y(x)=2.42 exp(0.03 x), wherein the x direction is assumed to be in the axial direction and the y direction is assumed to be in the radial direction.

In both embodiments, the first region with the length L1 is shorter than the second region with the length L2. The ratio of L1 to L2 is approximately 0.3.

The numbers given in these examples should be understood to be merely illustrative, and therefore other embodiments can have different dimensions.

In FIG. 5, the reduced mass flow through a pre-swirl nozzle 1 is plotted against the applied pressure ratio. Here, the squares indicate the data points for the reduced mass flow in the case of a pre-swirl nozzle known from the prior art with a constant cross section. It can be seen that the reduced mass flow has a pronounced, approximately logarithmic, dependence.

In contrast, the triangles in FIG. 5 indicate the data points for an embodiment according to FIG. 3. After a relatively sharp rise in the reduced mass flow, it remains constant over a wide range of the applied pressure difference. This allows easier optimization of the reduced mass flow for different operating points.

It goes without saying that the invention is not limited to the embodiments described above, and various modifications and improvements can be made without departing from the concepts described here. Any of the features may be used separately or in combination with any other features, unless they are mutually exclusive, and the disclosure extends to and includes all combinations and subcombinations of one or more features which are described here.

### LIST OF REFERENCE SIGNS

1 pre-swirl nozzle
2 outlet opening of the pre-swirl nozzle
3 inlet opening of a rotating component of the turbine stage
4 rotating component of the turbine stage
5 stationary component
6 cooling air duct
10 pre-swirl nozzle system
D1 maximum diameter of the first region of the pre-swirl nozzle
D2 maximum diameter of the second region of the pre-swirl nozzle
L cooling air
L1 length of the first region of the pre-swirl nozzle
L2 length of the second region of the pre-swirl nozzle
M1 centre line of the first region of the pre-swirl nozzle
M2 centre line of the second region of the pre-swirl nozzle
Q1 first cross section in the first region of the pre-swirl nozzle
Q2 second cross section in the second region of the pre-swirl nozzle
S flow direction of cooling air
α angle of a diffuser wall region to the centre line

1. Pre-swirl nozzle system in a gas turbine, in particular in an aircraft engine, having at least one pre-swirl nozzle, through which cooling air can flow,
wherein
the at least one pre-swirl nozzle has a region with a constant first cross section and a downstream region with a second cross section, which expands in the flow direction, in particular expands in a strictly monotonic manner.

2. Pre-swirl nozzle system according to claim 1, wherein the first cross section and/or the second cross section have/has a circular shape, a polygonal shape or an elliptical shape.

3. Pre-swirl nozzle system according to claim 1, wherein the centre lines of the first cross section and of the second cross section are in alignment in the flow direction.

4. Pre-swirl nozzle system according to claim 1, wherein the widening of the second cross section to form a diffuser takes place partially or entirely in a linear manner in the flow direction.

5. Pre-swirl nozzle system according to claim 4, wherein the region with the expanding second cross section forms a conical diffuser wall region of the pre-swirl nozzle.

6. Pre-swirl nozzle system according to claim 5, wherein the conical diffuser wall region of the pre-swirl nozzle has an angle of between 1 and 6°, in particular 2.5°, to the centre line.

7. Pre-swirl nozzle system according to claim 1, wherein the widening of the second cross section to form a diffuser takes place partially or entirely in a non-linear manner in the flow direction.

8. Pre-swirl nozzle system according to claim 7, wherein the non-linear widening of the second cross section forms a diffusor wall region which expands exponentially in the flow direction.

9. Pre-swirl nozzle system according to claim 1, wherein the widening of the second cross section takes place partially in a linear manner and partially in a non-linear manner.

10. Pre-swirl nozzle system according to claim 1, wherein the transition between the region with the constant first cross section and the downstream region with the second cross section has a sharp edge or a rounding.

11. Pre-swirl nozzle system according to claim 1, wherein the maximum diameter of the first cross section of the pre-swirl nozzle is between 1 and 12 mm, in particular 5 mm.

12. Pre-swirl nozzle system according to claim 1, wherein the maximum diameter of the second cross section of the pre-swirl nozzle is greater than the first cross section and is between 2 and 13 mm, in particular 6 mm.

13. Pre-swirl nozzle system according to claim 1, wherein the ratio of the length of the region of the first cross section to the length of the region with the second cross section is between 0.1 and 0.5, in particular 0.3.

14. Pre-swirl nozzle system according to claim 1, wherein the direction of the outlet opening of the pre-swirl nozzle is aligned with the direction of an inlet opening of a rotating component of the turbine stage.

15. Pre-swirl nozzle method using a pre-swirl nozzle system according to claim 1, wherein the exit velocity of the cooling air from the pre-swirl nozzle can be set by means of the geometry of the cross sections, independently of the mass flow of the cooling air.
